(19) United States
(12) Patent Application Publication
(10) Pub. No.: US 2025/0061175 A1
(43) Pub. Date: Feb. 20, 2025

(54) AUTOMATIC OBJECT IDENTIFICATION AND SERIALIZATION

(71) Applicant: Alitheon, Inc., Bellevue, WA (US)

(72) Inventors: Will Charles Shannon, Newcastle, WA (US); Roei Ganzarski, Redmond, WA (US); Mark Tocci, Redmond, WA (US)

(21) Appl. No.: 18/808,423

(22) Filed: Aug. 19, 2024

Related U.S. Application Data
(60) Provisional application No. 63/520,224, filed on Aug. 17, 2023.

(51) Int. Cl. G06F 21/30; G06T 7/00; G06V 10/44

(52) U.S. Cl. CPC G06F 21/30; G06T 7/0002; G06V 10/44; G06T 2207/30168

(57) ABSTRACT

A method includes capturing a plurality of digital images of a physical object. While capturing the plurality of digital images, for each of the captured digital images: whether the digital image is of sufficient quality to determine an object type for the physical object is determined in real-time; an object type for the object is determined in real-time; and whether the digital image is of sufficient quality to generate a digital fingerprint for the physical object from digital image data of the digital image is determined in real-time. The method also includes: extracting features from one or more authentication regions of a digital image of the plurality of digital images, which has been determined to be of sufficient quality to generate a digital fingerprint for the physical object from digital image data of the digital image; and generating a digital fingerprint for the object based on the extracted features.

### CROSS-REFERENCE TO RELATED APPLICATIONS

This application is a non-provisional application of, and claims priority pursuant to 35 U.S.C. Section 119 to U.S. Provisional Patent Application No. 63/520,224, filed Aug. 17, 2023, and titled “AUTOMATIC OBJECT IDENTIFICATION AND SERIALIZATION,” which is hereby incorporated by reference herein in its entirety.

### BACKGROUND

The present disclosure pertains to systems, methods, and apparatus associated with digital fingerprints generated with data extracted from a digital image of an authentication region on a physical object. More particularly, but not exclusively, the present disclosure relates to scanning, processing, and repository (e.g., database) techniques to continuously capture image data of a physical object until sufficient data has been captured to identify the object type that is scanned and to then serialize the object based on the captured image data, or to identify the physical object based on a comparison of the newly created digital fingerprint to digital fingerprints existing in the repository.

Some aspects of technologies and related art that may be useful in understanding the present disclosure are described in the following publications, which are each incorporated herein by reference in their respective entirety:
U.S. patent application Ser. No. 15/862,556, which is also published U.S. Patent Publication No. 2018/0144211 A1 by Ross et al., which describes, among other things, a database for detecting counterfeit items using digital fingerprint records;
U.S. patent application Ser. No. 13/618,362, which is also U.S. Pat. No. 9,152,862 by Ross et al., which describes, among other things, embodiments of digital fingerprinting;
U.S. patent application Ser. No. 14/531,724, which is also U.S. Pat. No. 9,443,298 B2 by Ross et al., which describes, among other things, digital fingerprinting object authentication and anti-counterfeiting systems;
U.S. patent application Ser. No. 15/436,631, which is also U.S. Pat. No. 10,037,537 B2 by Withrow et al., which describes, among other things, personal history in track and trace systems, and
U.S. patent application Ser. No. 15/436,616, which is also U.S. Pat. No. 10,346,852 by Ross et al., which describes, among other things, embodiments of preserving authentication under item change.

Many different approaches have been tried to uniquely identify and authenticate physical objects, including labelling and tagging strategies using serial numbers, bar codes, holographic labels, RFID tags, and hidden patterns using security inks or special fibers. All of these methods can be duplicated, and many add a substantial extra cost to the production of the goods sought to be protected. Moreover, physical labels and tags may be lost, modified, or stolen, and the physical marking of certain objects such as artwork, gemstones, and collector-grade coins may damage or destroy the value of the object.

A need remains for solutions that enable the efficient identification of an object's type, the identification of object data sufficient for accurately uniquely identifying the object, determination of an object's unique identity or authenticity, where such solutions does not rely on the addition of some otherwise unnecessary attribute or proxy to the physical object.

### SUMMARY

In a general aspect, the techniques described herein relate to a method that includes capturing a plurality of digital images of a physical object. The method also includes, while capturing the plurality of digital images, for each of the captured digital images: determining in real-time if the digital image is of sufficient quality to determine an object type for the physical object from digital image data of the digital image; determining in real-time an object type for the object when the digital image is of sufficient quality to determine an object type for the physical object from digital image data of the digital image; and determining in real-time if the digital image is of sufficient quality to generate a digital fingerprint for the physical object from digital image data of the digital image. The method also includes: extracting features from one or more authentication regions of a digital image of the plurality of digital images, which has been determined to be of sufficient quality to generate a digital fingerprint for the physical object from digital image data of the digital image; and generating a digital fingerprint for the object based on the extracted features.

Implementations can include one or more of the following features, alone or in any combination with each other. For example, the method can further include storing the digital fingerprint for the physical object type in an authentication database to induct the physical object into the authentication database. The method can further include: comparing the generated digital fingerprint to a plurality of stored digital fingerprints; and determining a match between the generated digital fingerprint and one of the stored digital fingerprints to authenticate the physical object. The physical object can be re-positioned relative to a camera used to capture the plurality of digital images between captures of different digital images of the plurality of digital images. One or more indications can be provided to a user when a digital image is of sufficient quality to determine a digital fingerprint for the physical object from digital image data of the digital image. One or more indications can be provided to a user when a digital image is of insufficient quality to generate a digital fingerprint for the physical object from digital image data of the digital image. Determining if each digital image is of sufficient quality to generate a digital fingerprint for the physical object from digital image data of the digital image can include determining whether the digital image data of the digital image satisfy a plurality of quality metrics. The quality metrics can include at least one of a distance quality metric, a focus quality metric, an illumination metric, a rotation metric, and a noise metric. The quality metrics can be measured based on digital image data from the one or more authentication regions in the digital image. A plurality of indications can be provided to a user, each indication representing a different one of the plurality of quality metrics, and each indication indicating whether a digital image satisfies the quality metric represented by the indication, where satisfying the quality metric is a requirement for generating a digital fingerprint for the physical object from digital image data of the digital image. The method can further include: determining, for each digital image, a total quality metric based on the quality metrics measured for the image, extracting features from one or more authentication regions of the digital image of the plurality of digital images, which has been determined to have a highest total quality metric of the plurality of digital images; and generating the digital fingerprint for the object based on the extracted features. Capturing the plurality of digital images of the physical object can include capturing the plurality of digital images at a rate greater than or equal to 24 Hz. Determining in real-time if the digital image is of sufficient quality to generate a digital fingerprint for the physical object from digital image data of the digital image can occur within 0.5 seconds of the capture of the digital image. Capturing the plurality of digital images of the physical object can include capturing the plurality of digital images at a rate greater than or equal to 60 Hz.

In another general aspect, the techniques described herein relate to a system including: a scanner configured for capturing a plurality of digital images of a physical object; machine-readable memory storing executable instructions; one or more processors configured to execute the stored instructions to cause the system to: while the scanner captures the plurality of digital images, for each of the captured digital images: determine in real-time if the digital image is of sufficient quality to determine an object type for the physical object from digital image data of the digital image; determine in real-time an object type for the object when the digital image is of sufficient quality to determine an object type for the physical object from digital image data of the digital image; and determine in real-time if the digital image is of sufficient quality to generate a digital fingerprint for the physical object from digital image data of the digital image. The one or more processors are further configured to execute the stored instructions to cause the system to: extract features from one or more authentication regions of a digital image of the plurality of digital images, which has been determined to be of sufficient quality to generate a digital fingerprint for the physical object from digital image data of the digital image; and generate a digital fingerprint for the object based on the extracted features.

Implementations can include one or more of the following features, alone or in any combination with each other. For example, the system can further include a display configured for providing one or more indications to a user when a digital image is of sufficient quality to determine a digital fingerprint for the physical object from digital image data of the digital image. Determining if each digital image is of sufficient quality to generate a digital fingerprint for the physical object from digital image data of the digital image can include determining whether the digital image data of the digital image satisfy a plurality of quality metrics, where the quality metrics are measured based on digital image data from the one or more authentication regions in the digital image. The quality metrics can include at least one of a distance quality metric, a focus quality metric, an illumination metric, a rotation metric, and a noise metric. The one or more processors can be further configured to execute the stored instructions to cause the system to determine, for each digital image, a total quality metric based on the quality metrics measured for the image, extract features from one or more authentication regions of the digital image of the plurality of digital images, which has been determined to have a highest total quality metric of the plurality of digital images; and generate the digital fingerprint for the object based on the extracted features. The scanner can be configured for capturing the plurality of digital images of the physical object at a rate greater than or equal to 24 Hz and wherein determining in real-time if the digital image is of sufficient quality to generate a digital fingerprint for the physical object from digital image data of the digital image occurs within 0.5 seconds of the capture of the digital image.

### BRIEF DESCRIPTION OF THE DRAWINGS

FIG. 1 illustrates two wine bottle labels; one of the labels having a delineated anchor region and a delineated authentication region defined when the label is flat.

FIG. 2 is a schematic diagram of a wine bottle bearing the same two labels of FIG. 1 and illustrating the skewed vintner's name caused by the curvature of the wine bottle.

FIGS. 3A and 3B are schematic diagrams of system for generating a digital fingerprint of physical objects.

FIG. 4 is a schematic diagram of an example system for providing feedback regarding the quality of image data that is captured by the system.

FIG. 5 is an example flowchart of a process for generating a digital fingerprint for a physical object.

FIG. 6 is a schematic diagram of an example architecture of a computing system that can be used to implement aspects of the present disclosure.

### DETAILED DESCRIPTION

Certain embodiments demonstrating the art of applying digital fingerprint technologies to identify, trace, and authenticate a physical object have already been disclosed in many publications by the present inventive entity. As disclosed in these publications, digital fingerprints are generated from data derived from a digital image. The digital image can be taken of the entire physical object, or of an authentication region of the physical object, where the physical object is to be identified or authenticated. The authentication region is an area of the physical object having sufficient inherent structures from which item unique object features may be extracted and from which item unique feature vectors may be formed. It is recognized, however, that a suitable authentication region on a physical object may not be readily apparent to a human or machine-system arranged to capture the digital image data or may be time consuming to take a single image of each physical object. Hence, the device, method, and system embodiments described in this disclosure (i.e., the teachings of this disclosure) determine a readily discernible anchor region of the physical object—and use the anchor region to automatically localize the authentication region of the physical object, and do so in a continuous manner, not requiring a user to take a single image.

This disclosure teaches using a feature or features on a physical object as the “anchor region” or “anchor regions” to locate, triangulate, or otherwise identify the authentication region or authentication regions of the object, and to do so in a continuous manner, without requiring the user to take an individual image.

Concurrently, the processing of the anchor region data can provide substantial confidence that the digital image of those authentication regions is adequate for extraction of authentication data that can be used to uniquely identify the specific physical object. These new techniques of continuously capturing images of an object and extracting authentication data from such digital image data, which is sometimes referred to as “digital fingerprinting,” are described in more detail herein.

In this disclosure, examples are given that involve the use of image-based authentication features such as are known in machine-based understanding of images. However, it is to be understood that any suitable image-based forms of authentication are in view.

This disclosure has in view, in some embodiments, a process of continuously capturing images of an object, including one or more authentication regions, evaluating the quality of the captured images, determining that a captured image is a sufficient quality to identify an object type and to serialize the object, and automatically extracting unique authentication data from an authentication region that is also visible in the captured image and which meets the criteria for sufficient quality to identify that object.

In another embodiment, a system processes anchor region image data to extract a location of an authentication region of interest and, if the authentication region is not included in the captured image of the anchor image, the system directs a user or processor-executable application as to where and/or how to capture an image of the authentication region of interest. In these or other embodiments, a process may include accessing a database, based on data extracted from the anchor region image, to acquire offset information. The offset information is used to locate the authentication region of interest and to extract unique authentication information from digital image data of the authentication region.

To describe the manner in which the above-recited and other advantages and features of the disclosure can be obtained, a more particular description follows by reference to the specific embodiments thereof which are illustrated in the appended drawings. Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings.

Understanding that these drawings depict only some embodiments of the present disclosure and are not therefore to be considered to be limiting of its scope, one or more embodiments of the present disclosure will be described and explained with additional specificity and detail through the use of the accompanying drawings in which:

The present disclosure may be understood more readily by reference to this detailed description and the accompanying figures. The terminology used herein is for the purpose of describing specific embodiments only and is not limiting to the claims unless a court or accepted body of competent jurisdiction determines that such terminology is limiting. Unless specifically defined herein, the terminology used herein is to be given its traditional meaning as known in the relevant art.

Improvements to digital fingerprint technology are taught in the present disclosure. Digital fingerprints, as the term is used herein, can be utilized in many practical applications including the identification, authentication, and tracing of physical objects. Rather than repeating each potential application, the present disclosure is simplified by interchangeably using the terms, “authenticate” and “identify.” along with their cognates. One of skill in the art will recognize that unless the context dictates otherwise, various acts described with respect to the authentication of a physical object may also be applied to the identification of a physical object, the tracing of a physical object, and the performance of other like acts associated with the physical object. And along these lines, acts described with respect to identifying a physical object may also be applied to authenticating, tracing, and performing other like acts associated with the physical object.

Many different approaches have been tried to uniquely identify and authenticate objects, including proxies such as labelling and tagging strategies using serial numbers, bar codes, holographic labels. RFID tags, and hidden patterns using security inks or special fibers. All of these methods can be duplicated, and many add a substantial extra cost to the production of the goods sought to be protected. Nevertheless, these labels, tags, and other areas of a physical object may be used as an “anchor region” (e.g., a reference point) to locate an authentication region on the physical object.

The device, method, and system embodiments described in this disclosure (i.e., the teachings of this disclosure) enable a machine-based entity to: 1) continuously capture digital image data of a physical object, 2) from that digital image data, automatically locate an authentication region on the physical object, 3) determine whether the authentication region digital image data satisfies one or more quality criteria to permit serializing the object from the digital image data and, if not, then continue capturing additional authentication region digital image data unit until the captured digital image data satisfies the one or more quality criteria, and 4) generate at least one unique digital fingerprint from the authentication region digital image data.

The term “digital fingerprint” in all its grammatical forms and constructs, is used throughout the present specification and claims to refer to a computationally unique digital identifier of a physical object or a portion of a physical object. To the limitations of the available computational resources, each and every digital fingerprint identifying a determined portion of a physical object is different from each and every other digital fingerprint identifying a different physical object or identifying a different portion of the same physical object. And to the limitations of the available computational resources and the preservation of the determined portion of the physical object on which a first digital fingerprint is generated, each and every subsequent digital fingerprint identifying the same determined portion of the same physical object is statistically the same as the first digital fingerprint In at least some cases, a digital fingerprint, as the term is used herein, is generated in a method that includes acquiring a digital image, finding unique features within that digital image (e.g., generally, regions of disparity where “something” is happening, such as a white dot on a black background or the inverse), and characterizing those unique features into one or more unique feature vectors extracted from the digital image. Characterizing the unique features may include assigning image values, assigning or otherwise determining a plurality of gradients across the image region, or performing some other technique. The extracted unique feature vectors may or may not be analyzed or further processed. Instead, or in addition, the extracted unique feature vectors that characterize the unique features in a region are aggregated, alone or with other information (e.g., with location information) to form a digital fingerprint.

In embodiments of the present disclosure, digital fingerprinting includes the creation and use of digital fingerprints derived from unique properties of a physical object. The digital fingerprints are typically stored in a repository such as a register, a physical memory, an array, a database, data store, or some other repository. Storing the digital fingerprint in the repository may include, or in some cases be referred to as, inducting or registering the respective physical object into the repository. Digital fingerprints, whether immediately generated or acquired from a repository, may be used to reliably and unambiguously identify or authenticate corresponding physical objects to an acceptable level of certainty, trace the physical objects through manufacturing, supply chains, in the marketplace, during product returns, and record their provenance and changes over time. Many other uses of digital fingerprints are of course contemplated.

Digital fingerprints store information, preferably in the form of numbers or “feature vectors,” that describe unique features that appear at particular locations, of a two-dimensional (2-D) or three-dimensional (3-D) object. In the case of a 2-D object, the unique features are preferably on a surface of the corresponding object; in the 3-D case, the unique features may be on multiple surface levels of the object. In some applications, an object “feature template” may be used to define locations or regions of interest for a class, or type, of objects. The digital fingerprints may be derived, or generated, from digital data of the object which may be, for example, image data.

Feature extraction or feature detection may be used to characterize unique features. In an embodiment, this may be done in various ways. Two examples include but are not limited to Scale-Invariant Feature Transform (or SIFT) and Speeded Up Robust Features (or SURF). Both are described in the literature. For example. “Feature detection and matching are used in image registration, object tracking, object retrieval etc. There are number of approaches used to detect and matching of features as SIFT (Scale Invariant Feature Transform), SURF (Speeded up Robust Feature), FAST, ORB, etc. SIFT and SURF are useful approaches to detect and matching of features because of it is invariant to scale, rotate, translation, illumination, and blur.” MISTRY, Darshana et al., Comparison of Feature Detection and Matching Approaches: SIFT and SURF, GRD Journals-Global Research and Development Journal for Engineering|Volume 2|Issue 4|March 2017.

In an embodiment, features may be used to represent information derived from a digital image in a machine-readable and useful way. Features may comprise point, line, edges, blob of an image, etc. There are areas such as image registration, object tracking, and object retrieval, etc., that require a system or processor to detect and match correct features. Therefore, it may be desirable to find features in ways that are invariant to rotation, scale, translation, illumination, and/or noisy and blurred images. The search for unique features from one object image to corresponding images can be very challenging work. The search may preferably be done such that the same physical unique features may be found in different views. Once located, unique features and their respective characteristics may be aggregated to form a digital fingerprint, which may include 2-D or 3-D location parameters.

In an embodiment, features may be matched, for example, based on finding a minimum threshold distance. Distances can be found using Euclidean distance, Manhattan distance, or other suitable metrics. If distances of two unique features are less than a prescribed minimum threshold distance, those key unique features may be known as matching pairs. Matching a digital fingerprint may comprise assessing a number of matching pairs, their locations, distance, or other characteristics. Many unique features may be assessed to calculate a likelihood of a match, since, generally, or at least in some cases, a perfect match will not be found. In these cases where a perfect match is not found, a match may still be asserted when the features are matched to within a predetermined similarity threshold or some other acceptable level of confidence. In some applications a “feature template” may be used to define locations or regions of interest for a class, or type, of objects.

The terms “induction,” “serialization,” and “registration” as used in the present disclosure, refers to acts that include generating and storing, or otherwise acquiring access to, at least one digital fingerprint of a physical object, and storing the one or more digital fingerprints in a repository. Each stored digital fingerprint may be communicatively linked (i.e., associated) with other information related to the physical object. Hence, induction may also include acts that store additional information related to the physical object in a same or different repository. The additional information may be stored in association with any number of digital fingerprints. The association may include storing associated data in a common or shared repository record, communicatively linking one or more repository records together, or via other techniques known in the art to link information. For the sake of illustration and not limitation, induction may include storing one or more digital fingerprints in a new or existing repository record and further storing some other type of information, whether related to one or both of the physical object and the digital fingerprint, in a same or linked repository record.

### Scanning

In the present disclosure, the term, “scan,” in all of its grammatical forms, refers illustratively and without limitation to any and all means for capturing data from a physical object, including an image or set of images, which may be in digital form or transformed into digital form. Images may, for example, be two dimensional (2-D), three dimensional (3-D), or in the form of video. Thus, a scan may refer to a collection of scan data, including one or more images, or digital data that defines such an image or images, captured by a scanner, a camera, an imager, a 3D-sense device, a LiDAR-based device, a laser-based device, a specially adapted sensor or sensor array (e.g., a CCD array), a microscope, a smartphone camera, a video camera, an x-ray machine, a sonar, an ultrasound machine, a microphone (i.e., any instrument for converting sound waves into electrical energy variations), and the like. Broadly, any device that can sense and capture either electromagnetic radiation, a light wave (visible or invisible), or a mechanical wave that has traveled through an object or reflected off an object, or any other means to capture surface or internal structure of an object, is a candidate to create a scan of an object.

Various means to extract features from an object may be used. For example, features may be extracted through sound, physical structure, chemical composition, or many other means. Accordingly, while the term, images, and cognates of the term, images, are used to form the digital fingerprints described herein, the broader application of scanning technology will be understood by those of skill in the art. In other words, alternative means to extract unique features from an object and to generate a digital fingerprint that uniquely identifies the object should be considered equivalents within the scope of this disclosure. Along these lines, terms such as “scanner,” “scanning equipment,” “sensor,” “sensor array,” and the like as used herein may be understood in a broad sense to refer to any equipment capable of carrying out scans as described above, or to equipment that carries out scans as described above, as part of their function to produce sensor data (e.g., scan data, image data, x-ray data, acoustic data, ultrasound data, audio data, or the like).

When capturing digital images that will be used to perform an authentication of a physical object, it is desirable that the authentication regions be consistently illuminated, in proper focus, properly located, and—in some cases properly sized and oriented. By providing these circumstances during a scan of the physical object, the authentication process is more likely to be supplied with serviceable data. Since the information used for authentication is often very different from what is acted on by human perception, it can be hard for a user to tell when a digital image of an authentication region is adequate for generating a unique digital fingerprint for the object. This may be harder to achieve in cases, such as where the object in question is not flat (e.g., the label on a wine bottle), where the object has image regions of substantially different contrast (e.g., a passport with a photograph, regions of text, and regions of background), or where the object has regions lacking features that humans are used to reading or understanding (e.g., if the authentication region only contains paper fibers or a simple metallic surface).

The ability to use less than well imaged authentication regions is made more important by the desire to use inexpensive and readily available capture equipment, such as the camera on a smartphone, which may have limited depth of field, contrast sensitivity, and so on, and whose distance and orientation with respect to the object may not be accurately known. If there is limited information provided as to where on the object the authentication region is located, and from how the location and orientation from which it was imaged, the user may be constrained to estimate, and such estimating with regard to capturing the digital image data might result in the digital image of the authentication region being missed or out of focus. Alternatively, or in addition, such estimating may cause the user to image the entire object, which may result in an image of insufficient resolution to provide robust authentication. In some cases, it might be impossible to clearly generate digital image data of all possible locations of the authentication regions (e.g., of the label on a curved wine bottle) at the same time.

Characteristics of an authentication region that improve the usefulness of the region for serialization and authentication may not be apparent to the human eye. For example, when features such the paper fibers or the ink bleeds of a wine label are to be used for serialization and authentication of a wine bottle, it is difficult to direct a smart phone camera application to clearly capture a focused digital image of the paper fibers or the ink bleeds, because autofocus techniques of the smart phone camera may focus on larger features, such as the shape if the bottle or the writing on the label. In cases where there is no feedback to the user and/or the application as to whether a sufficiently detailed image of the paper fibers or the ink bleeds of the wine label is captured, the determination of whether or not the digital image data of the authentication region is sufficient for serialization and authentication may, therefore, become a matter of chance, and multiple attempts to capture adequate digital image data of the authentication region from a single image may be required. As a result of the poor digital image data quality, the ability to determine with an acceptable level of confidence that successful serialization or authentication has been achieved or has failed can become difficult. If, in particular, the original digital image of the physical object that was analyzed when the object was first inducted into a repository (i.e., the induction image of the object) and the later captured digital image of the purported physical object (i.e., the authentication image) have different areas in clear focus, it is possible that any authentication of the physical object will be weak or nonexistent. Without prompting or guidance, it is in at least some cases not possible for a user in the field who is performing an authentication to know what area of the physical object was in focus (i.e., captured in a digital image) when the object was originally inducted. Using current techniques, the user who is trying to authenticate the object makes any number of guesses as to what parts of the object should be imaged to produce sufficiently detailed digital images on which to perform the authentication. What's more, if the physical object that the user is trying to authenticate has never been inducted, then the user may not be able to know whether the digital image data quality prevented induction or whether the object had never yet been inducted. In addition, if during the induction process, objects are not imaged uniformly, for example, with requisite point-of-views (POVs), focus, motion blur, location and alignment relative to a scanner, etc., then authentication of an object at a later time can be difficult, or the authentication can be prone to error. Hence, the need remains for better solutions to address these and related problems.

Anchor regions on a physical object are regions of the physical object that are more easily recognized by a human user or a computer-based application. Anchor regions may be inherent features of the object itself (e.g., the name of a vintner on a wine label), anything added or incorporated for the purpose (e.g., an “FEATUREPRINTED BY ALITHEON” seal), or any other structure or characteristic that is easy or intuitive to locate, preferably through training or other means. In at least some cases, the anchor region or anchor regions are easily located by the naked eye. A large number and variety of methods that find: 1) one or more anchor regions, 2) one or more authentication regions, and/or 3) the relationships among the anchor regions and authentication regions are in view in this disclosure.

One notable aspect of this disclosure is the use of one or more areas on an object (e.g., one or more first “anchor regions”) to identify other or possibly the same regions on the object (e.g., one or more second anchor regions or “authentication regions”). The capture and contents in digital image data of the first anchor region provide information on a second anchor region or an authentication region on the object that can be used for authentication of the object.

The regions on the physical object whose digital image data is used for authentication may be termed “authentication regions of interest” or “authentication regions.” In general, the anchor regions may be easier or more intuitive to locate. In addition, in at least some cases, the anchor regions are less suitable for authentication than the authentication regions of interest.

To facilitate capture of adequate digital image data of physical objects users are trying to authenticate, in some implementations, feedback may be provided to users regarding the quality of the digital image data captured by each user. For example, after an image of a physical object is captured (either when the object is initially inducted or when authentication of the object against an existing fingerprint is performed), the system can provide to a user an indication that the digital image data was adequately captured for authentication analysis or an indication the digital image data is not adequate for authentication analysis and must be recaptured. The indications may be generated based on the quality of the digital image data as a whole and/or based on the quality of one or more authentication regions within the digital image data. In another implementation, when an object is initially inducted or when an object is authenticated against an existing fingerprint, the object can be scanned repeatedly to generate a series of images of the object, and each image of the series can be evaluated to determine whether it was adequately captured for authentication analysis, and the image can be repeatedly scanned until an image is captured, which is determined to be adequate for authentication analysis. Then, once the determination has been made that an image adequate for authentication analysis has been captured, an indication of such a determination can be provided to the user, so that the user can stop scanning the object.

In one exemplary process, quality indications may be generated by, processing digital image data of a physical object and/or a particular portion of the digital image data to locate an anchor region, for example, processing a portion of digital image data of a wine bottle that contains the label to locate a first anchor region included in the label. One or more quality metrics describing a property of the portion of digital image data may then be generated. The one or more quality metrics may include a qualitative or quantitative description of the clarity, focus, resolution, contrast, illumination, orientation, or other properties of the portion of digital image data. For example, the one or more quality metrics may comprise at least one of: clarity of focus of a portion of the digital image data including the anchor region, an illumination of the portion of the digital image data including the anchor region, a size of the portion of the digital image data including the anchor region, or an orientation associated with the portion of the digital image data including the anchor region. The quality of the portion of digital image data may then be assessed by comparing one or more of the quality metrics to predetermined threshold values. If the one or more quality metrics of the portion of digital image data satisfy the predetermined threshold values, the digital image data of the anchor region may be determined to be adequately captured. When digital image data of the anchor regions is adequately captured, the related regions of interest (e.g., one or more second anchor regions or authentication regions) will generally be captured as well, either at the same time, which may be the general case, or as a result of using data sent back from a database whose access is triggered by capturing and processing the anchor region(s). In the latter case, in response to determining the digital image data of the anchor region is adequately captured, a reference database may be accessed to retrieve a repository (e.g., database) record may provide “instructions” for where and how to capture the one or more authentication regions of interest. For example, a repository record describing how to locate an authentication region in the portion of digital image data may be accessed using data of the anchor region. The repository region may include offset information that locates the authentication region in the portion of digital image data.

In some implementations, a continuous plurality of images can be captured, and image quality metrics can be determined in real-time for each of the captured images, for example, within one second, or within 0.5 seconds, or within 0.25 seconds of the capture of the image. If the one or more quality metrics for an image fail to satisfy the predetermined threshold, the portion of the digital image data may automatically be re-imaged to capture re-imaged digital image data of the anchor region. When the digital image data is re-imaged, it can be re-imaged from a different location or from a different orientation, or with a different focus, or with different lighting, etc. than used previously to image the digital image data. In some implementations, instructions to re-capture a second portion of digital image data including the anchor region may also be generated and provided to the user, in response to determining one or more quality metrics for the portion of digital image data do not satisfy the predetermined threshold. Once the digital image data is re-imaged and/or the second portion of digital image data is captured, one or more quality metrics for the re-imaged digital image data and/or the second portion of digital image data may be generated. The one or more quality metrics for the re-imaged digital image data and/or the re-captured second portion of digital image data may describe one or more properties of the digital image data as described above. To determine if the re-imaged digital image data and/or the second portion of the digital image data is adequately captured, the one or more metrics may be compared to the predetermined thresholds. The re-imaging of the digital image data can be repeated until the quality metrics indicate that the object has been adequately captured.

Other quality indications that may be provided during the capture process to ensure the digital image data is accurately captured relate to the placement of one or more authentication regions in digital image data captured by the scanner. To determine if the digital image data is adequately captured, the authentication region within the portion of digital image data, the re-imaged digital image data, and/or the second portion of digital image data may be assessed. If the authentication region is within view of the portion of digital image data, the re-imaged digital image data, and/or the second portion of digital image data, it may be determined that the portion of digital image data, the re-imaged digital image data, and/or the second portion of digital image data is adequately captured. The authentication region within the portion of digital image data, the re-imaged digital image data, and/or the second portion of digital image data may then be used for feature extraction.

If the authentication region is not within view of the portion of digital image data, the re-imaged digital image data, and/or the second portion of digital image data, the object can be repeatedly imaged while it is moved relative to the scanner or while the scanner is moved relative to the object until the authentication is within view. In some implementations, feedback for the scanner and/or a user of the scanner may be generated. The feedback may include an indication that the authentication region is not within view of any the portions of digital image data, the re-imaged digital image data, and/or the second portion of digital image data and/or instructions causing the scanner to automatically obtain and/or user of the scanner to obtain, based on the offset information, next digital image data representing an image of a second region of the physical object that includes a location corresponding to the authentication region and/or a second authentication region. The image of the second region of the physical object may then be processed to locate a second anchor region in the image of the second region. One or more quality metrics of the next digital image data of the second anchor region may then be generated. Each quality metric may then be compared to a respective predetermined threshold.

If the one or more quality metrics satisfy one or more of their respective predetermined thresholds, then the next digital image data may be determined to be adequately captured and the authentication region within the next digital image data may be used for feature extraction. If the one or more quality metrics for the next digital image data fail to satisfy one or more of their respective predetermined thresholds, an indication that the next digital image data is not adequately captured may be provided to the scanner and/or a user of the scanner. In response, the scanner may automatically re-image the second region and/or the user may cause the second region to be re-imaged. Instructions for capturing a third portion of digital image data may also be provided to the scanner and/or a user of the scanner. The third portion of the digital image data may include the second anchor region.

The one or more quality metrics for the portion of digital image data, the re-imaged digital image data, the second portion of digital image data, and of the next digital image data may also include one or more qualitative and/or quantitative descriptions of whether digital image data including text has sufficient data so that the text could be successfully interpreted by object character recognition (OCR) techniques. The one or more quality metrics may also include a qualitative and/or quantitative description of whether digital image data and/or next digital image data includes a digital image that matches a determined template or reference within a predetermined threshold. Other quality metrics may describe whether digital image data contains a resolution pattern that is focused until a certain resolution within a predetermined threshold is found. The one or more quality metrics may also indicate whether digital image data of a bar code (e.g., a UPC code) has sufficient data such that the bar code is both readable and has a number of pixels across a stroke within a predetermined threshold. Other quality metrics may include a description of whether digital image data and/or next digital image data includes a logo where features within the logo are resolved to within a predetermined threshold and/or whether digital image data and/or next digital image data includes a label (e.g., an “FEATUREPRINTED BY ALITHEON” or other label) formed in type sufficiently small that, if it has a resolution within a predetermined threshold indicating it is readable by OCR techniques and/or the human eye.

The term “capture” is further explained elsewhere in this disclosure. The terms, “capture” and “scan,” and their cognates, may be used interchangeably in the present disclosure.

In a preferred embodiment, an anchor region has certain properties. First, the anchor region has a location that is clearly identifiable by the human eye or by an automatic computer-based application. The anchor region is easily and, in some cases, instinctually locatable. Second, there exists some acceptably simple approach to determine that the digital image of the anchor region is adequately captured, wherein adequately captured herein means that the digital image data is adequate for the purposes of the third property (described below). One non-limiting example of an adequately captured digital image is a digital image of text having sufficient data that the text could be successfully interpreted by object character recognition (OCR) techniques. Another non-limiting example of an adequately captured digital image is a digital image that matches a determined template or reference sufficiently well. A third property of an anchor region, in addition to, or in place, of the first and second properties, is that a process or computer-based application may automatically proceed to capturing adequate digital image data of the authentication region based on information associated with the anchor region.

In some cases, an authentication region may be the same region as the anchor region In other cases, an authentication region may be different from the anchor region. In still other cases, the authentication and the anchor regions may be overlapping in whole or in part, which is preferred in one embodiment. The capture of digital image data of the authentication region may be direct or indirect.

In the direct case, one or more authentication regions are already in view, and the process of authentication proceeds without further user intervention using the already-captured anchor region digital image data in these cases, features are extracted from the digital image data of the one or more authentication regions, and the extracted features are used, for example, to generate one or more digital fingerprints for induction of the physical object into a repository, for authentication of the physical object, or for some other purpose associated with the physical object.

In the indirect case, an associated system (e.g., a database record, a computer-based authentication system, or some other system) can instruct the user or a computer-based application to capture one or more digital images of one or more locations elsewhere on the physical object. The one or more supplementary digital images are digital images of the authentication region, and the instructions to capture this supplementary image data may be made with or without reference to another anchor region. With respect to the instruction to capture digital images from elsewhere on the physical object, “elsewhere” refers to one or more locations or regions on the physical object that were not included in the initial anchor region digital image capture. The user or computer-based application captures one or more additional digital images (i.e., the supplementary digital image data) at other locations according to the instructions. The instruction to the user or the to the computer-based application can be provided in a variety of different ways. For example, a visual indication (e.g., color of a light) can remain constant (e.g., red) until additional image data is captured that includes the authentication region(s) and until the additional image data satisfies predetermined quality metric thresholds, and then the visual indication can change (e.g., a color can change from red to green) after additional image data that includes the authentication region(s) is captured and the additional image data satisfies predetermined quality metric thresholds.

In some implementations, when digital image data of an anchor region is captured, feedback can be provided to the user indicating whether or not the anchor region has been successfully processed.

When digital image data of the anchor region is adequately captured, a computer-based application associated with that anchor region capture process can be provided with information that the one or more authentication regions of interest are also adequately captured (i.e., the direct case).

When digital image data of the anchor region is not adequately captured, a computer-based application associated with that anchor region capture process can be provided with instructions to adequately capture one or more digital images of the one or more authentication regions (i.e., the indirect case).

The quality of the initially captured digital image data (e.g., the clarity of focus of the anchor region) provides an indication that the authentication regions of interest will also be adequately captured with sufficient clarity to allow effective authentication to proceed.

Process results based on the initially captured digital image data, which may include recognition of the contents of the anchor region, may trigger a repository (e.g., database) access that provides information (e.g., location, scale, etc.) associated with the one or more authentication regions of interest, from which unique features will be extracted for authentication. Among the information associated with the one or more authentication regions of interest that may be provided to the user or to the computer-based application are specialized instructions directing the user or computer-based application on where and how to capture or otherwise process one or more authentication regions of interest to achieve acceptably optimal authentication.

Information received back from a repository (e.g., database) query may include instructions to a camera or other imaging device to, for example, turn on a light, switch to infrared, apply a particular mask to the digital image, switch to a plenoptic mode, zoom in or out, or take some other determined action to enable adequate capture of one or more authentication regions.

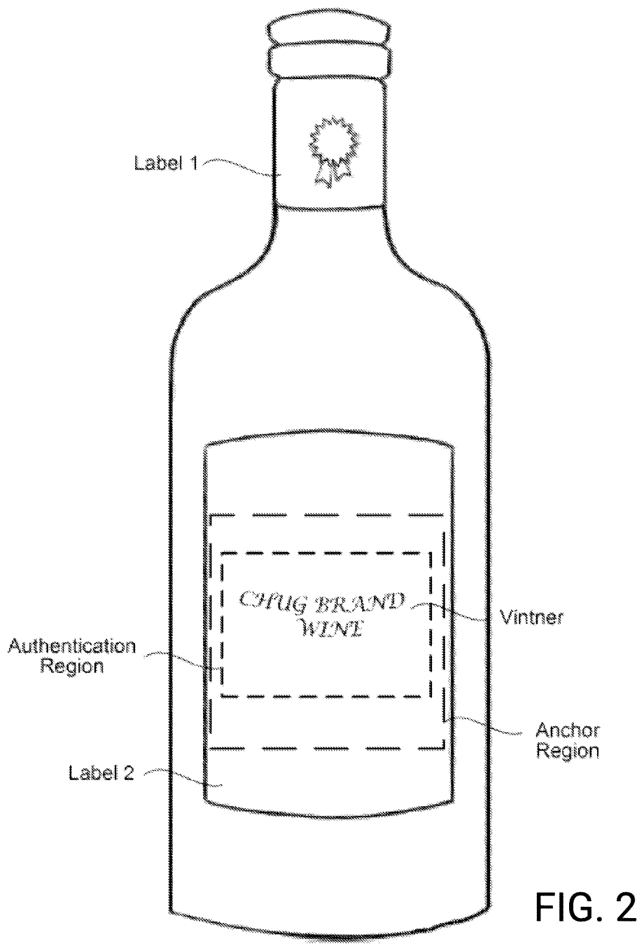

In one embodiment, an anchor region may be located within the object itself, on packaging of the object (e.g., on a bottle, on a cardboard box, on a plastic wrapper, etc.), within a label affixed to an object, etc. An example of this is shown in FIG. 2, as explained herein. An area including the anchor region can be captured in a digital image of the label shown in FIG. 2, along with more of the label. That region in the digital image data that is “more of the label” will in some cases include an authentication region although in some circumstances it may not. A repository is accessible that contains information (e.g., instructions) indicating a computer-based program is to offset from the anchor region to locate the authentication region. If the authentication region is in view in the digital image data that has already been captured, the system performs attempts to perform an authentication based on the captured digital image data. If the authentication region is not in view, the system can communicate back to the user or computer-based program that the authentication region is not in view and/or how to offset from the anchor region to locate the authentication region.

In a second embodiment, an anchor region can be void of any graphic or alphanumeric content that indicates where the authentication region is located. Rather, a repository (e.g., database) holds information regarding the location of the authentication region. For example, a template for a type of objects corresponding to identified anchor regions can include locations of one or more authentication regions in relation to the anchor regions, and the template can be retrieved from a data repository and used to identify the locations of the authentication regions. Thus, the locations of the authentication regions are retrieved from the repository based on information from the digital image data of the anchor region being presented for authentication and from having the digital image data of the anchor region as a starting point for offsetting and scaling to find the authentication region. For example, the repository can store information about digital image data for anchor locations that correspond to different classes, or types, of objects, and once anchor location(s) in the digital image data are identified for a particular class, or type, of object, the authentication regions for the identified object class, or type, can be determined.

Thus, in this second embodiment, the process queries the repository (e.g., database) with information on what class, or type, of object is being authenticated and with information drawn from the digital image capture of the anchor region. If the contents of the anchor region digital image data are clear enough to read or otherwise decode (e.g., text reading, bar code reading, or some other recognition), then it is presumed that the authentication region has been captured well enough to perform a serviceable authentication. From the knowledge of the class, or type, of object that is being authenticated, and from information drawn from the contents of the anchor region digital image, a repository query retrieves information instructing a user or computer-based application where to find the authentication region. If the authentication region is included in the digital image data that has already been captured (i.e., one normal situation), then the process templates that region and processes the digital image data to form digital fingerprints. If the authentication region is not included in the digital image data that has already been captured, then information retrieved from the repository (e.g., database) prompts the user or computer-based application on how and where to capture one or more digital images of the authentication region.

### A First Exemplary Embodiment

One non-limiting example is now described in which a resolution test pattern is included on a package for an object. The test pattern may be an “anchor region,” located on the flat surface of the package of the object and can be associate with the “authentication region of interest” area to be captured for induction of the package into a repository and, later, for authentication of the package. The user, who may be aided by computer-based application or who may be acting manually, captures one or more digital images of the anchor region. In some cases, a series of digital images can be captured repeatedly and continuously. The user or the computer-based application may change camera parameters (e.g., focus, shutter speed, torch, orientation and position relative to the object, and the like) until the test pattern shows with acceptably sufficient resolution. The acceptably sufficient resolution may be determined by visual inspection or by an automatic process.

The user, alone or in cooperation with a computer-based authentication application, will have access to information describing or otherwise representing the offset and scale from the test pattern anchor region to the authentication region. Because the orientation and scale of the test pattern are also determined, and because a repository (e.g., database) that is accessible to the user provides information describing the offset from the test pattern to the authentication region, the user can capture a digital image of the anchor region with proper resolution that also contains the authentication region. In cases where the authentication region is not captured in the same digital image as the anchor region, the information from the repository can notify the user to reposition the camera or other scanning device relative to the object, or can otherwise indicate that the authentication region has not been captured, so that additional digital image data is captured while the orientation and position of the camera relative to the object is changed (i.e., re-positioned). In at least some embodiments, a repository containing the information relating to authentication regions will be secure.

The first exemplary embodiment may include any suitable number of parameters. For example, the physical object or portions thereof that is imaged is non-limiting, how information about the physical object is determined is non-limiting, how the offset, scale, and other parameters of digital imagery are calculated is non-limiting, and the express acts of generating digital fingerprints, induction, authentication, tracing, and other acts may vary considerably and are also non-limiting. Certain methods of accomplishing each of these things are known to one of skill in the art and not described in detail herein. Other teaching, however, is described in detail. For example: when one or more digital images of one or more anchor regions in the exemplary test pattern are adequately captured, the results of that capture either provide adequate capture of the one or more authentication regions or provide sufficient detail so that instructions to adequately capture one or more digital images of the one or more authentication regions can be rendered. In other words, one region, which can be easily or intuitively located, brought into focus, oriented, and the like by a human or computer-based application, acts as a stand-in for, and guide to, capturing one or more digital images of another region that is more useful for authentication, but which may be much more difficult to adequately capture on its own. The anchor regions and authentication regions may, of course, be the same region. For example, a bar code may serve as the anchor region, and ink bleeds from the bar code may contain the features used for authentication. In another example, features common to a class, or type, of objects (e.g., words, lines, curves, colors, etc.) in a digital image may serve as an anchor region and may be used to identify the class, or type, of object that is being scanned, while features unique to a particular object of the class, or type, of objects may be used for authentication, or serialization, of the particular object.

### Further Exemplary Embodiments

The following exemplary embodiments are non-limiting. The following exemplary embodiments illustrate both a range of the current problem solved by the inventor and a range of exemplary solutions taught in the present disclosure.

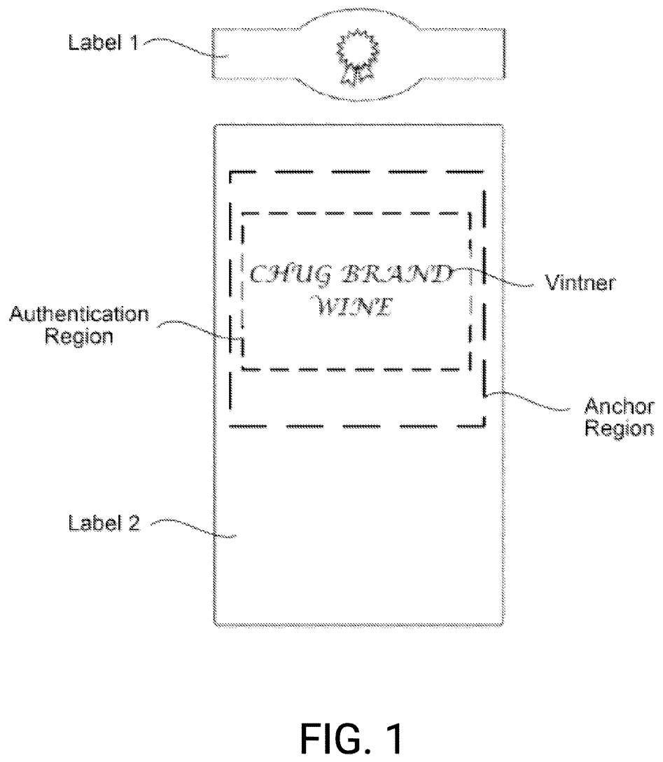

Another illustrative example is directed toward the authentication of a wine bottle by use of the label on the wine bottle. FIG. 1 illustrates a first Label 1 of a wine bottle neck and a second Label 2 of a wine bottle body. The first Label 1 has an “award” image on it, in this example, a star with a ribbon. The second Label 2 has text or any other markings, in this case, the name of the vintner, “CHUG BRAND WINE.” The second Label 2 also has an anchor region, as named in the FIG. 1. The anchor region includes the entire authentication region and some additional parts of Label 2 that are outside of the authentication region. In some embodiments, this part of the authentication region that is outside of the anchor region may or may not have additional text, figures, images, or icons, which are not shown in FIG. 1 for simplicity in the drawing.

The label of the wine bottle may be adequately captured in one or more digital images, which can be used to determine a type (or class) of the wine and to generate digital fingerprints that are inducted into a repository prior to application of the label to the bottle. For example, a user that is interested in authenticating many wine bottles of different types (e.g., where a type can refer to a grape varietal, a vintner, a vintage year, etc.) may be interested in uniquely identifying many different bottles of many different types of wine. Captured digital image data can be analyzed to determine a type of wine in the bottle, based, for example, on features in the digital images that are common to the type of wine (e.g., images, words, colors, patterns, etc. on the Label 1 and/or Label 2). Therefore, a user need not manually determine the type of wine and enter this information in a repository but rather the type of wine can be automatically determined based on the information in the captured digital image data. In some implementations, types of a product (e.g., types of wine) can be predetermined, and digital image patterns representing the different types can be stored for comparison to digital image data of unknown products that are scanned.

In addition, a wine bottle of a particular type can be uniquely identified (i.e., “serialized”) based on digital image data in an authentication region on the wine bottle. Both the determination of the type (class) of wine bottle and the serialization or the authentication of the wine bottle can be performed by continuously capturing digital image data of the wine bottle until the captured image data satisfies one or more quality metric thresholds to ensure that the determination of the type of wine and the serialization or authentication of the bottle based on the digital image data is performed with sufficient accuracy. Evaluation of the quality metrics of a digital image can be performed in real-time, as the digital image data of the bottle is being captured repeatedly, for example, within one second, or within 0.5 seconds, or within 0.25 seconds of the capture of the image, and once the quality metric thresholds are satisfied by the digital image data of a digital image, and indication can be provided to a user, so that the user can scan a next bottle.

As shown in FIG. 1, in some implementations, the induction process may be conducted when the label is flat, while later authentication may take place after the label has been applied to the bottle, as shown in FIG. 2. On a first Label 1 is an image and on a second Label 2 is the name of the vintner, which serves as at least part of the anchor region. The authentication region is determined, by some known method, to be a one-half inch square area located one inch around the vintner's name and centered on the vintner's name. This location might have been chosen for any of a number of reasons, one of which is that if the vintner's name is in focus after the label is applied to the bottle, then the authentication area is also likely to be in focus. One of skill in the art will recognize the variety of manners in which the one or more anchor regions may be communicated to a user, and the methods by which one or more authentication regions may be determined.

At induction, an area containing both the vintner name and the authentication region may be adequately imaged repeatedly by a scanner until both the vintner name and the authentication region are in sufficiently sharp focus and until the area is oriented and positioned relative to the scanner such that the type of wine can be determined and such that the wine bottle can be serialized based on digital image data captured in a scan. A template may be applied, and the authentication region may be converted into a set of unique features whose feature vectors are entered into a reference repository (e.g., database) along with any desired metadata relating to the bottle of wine. Details, such as how the authentication region is determined, what metadata is tied to the wine bottle records stored in the repository, whether authentication is one-to-one (e.g., as in cases where there is, for example, a serial number) or one-to-many (e.g., as in cases where there is, for example, a region of the vineyard where grapes were harvested to make several bottles of wine), what data is in a template or how the data from the template is applied, how the reference repository (e.g., database) is accessed, and other such details may be implemented in many ways, all of which details are in view here. During induction, dozens, hundreds, thousands, or any number of labels can be individually inducted into the system by scanning rapidly, then generating and storing one or more digital fingerprints for each label.

As shown in FIG. 2, when the wine bottle having a label thereon that has been inducted is to be authenticated at a later time, the user will continuously capture one or more digital images that include the vintner's name on the label and a region around that portion of the label. In some cases, a computer-based application may be employed to drive the camera or other scanning unit until sufficiently clear, sharp, and recognizable imagery of the vintner's name is adequately captured.

FIG. 2 illustrates the labels of FIG. 1 applied to a wine bottle. As can be seen, Label 1 is placed around the neck of the bottle and fully wraps around the neck. The two ends of label 1 overlap each other, with one end covering the other end, not shown in FIG. 2, but which can easily be understood. Thus, part of Label 1 that was fully viewable and imaged in FIG. 1 is hidden, cannot be seen, and is not present in any images taken in FIG. 2. In addition, the image on Label 1, which in this instance, is a star with a ribbon, is spread out more and slightly enlarged due to being placed on the curved neck of the bottle. The image on the Label 1 from FIG. 1 is now distorted. The improvements as disclosed herein can also provide techniques to properly recognize the same Label 1 after it is applied to the bottle and distorted or changed in shape.

Label 2 is placed on the main body of the bottle. The text, in this instance, the name of the vintner, is distorted because of the curve of the bottle. The Label 2 has an anchor region and an authentication region that are also distorted because of the curve of the bottle. Despite the distortion, the image of the anchor region can be used to locate the authentication region. The Label 2 that was digitally fingerprinted when the label was flat in FIG. 1 can be confirmed to be the same Label 2 that is shown in FIG. 2, even though the text and other parts of the Label are significantly distorted.

In this example, the simple transition of putting a flat label on a curved wine bottle is shown for ease of understanding. As can be appreciated, the label may start in any shape, flat, curved, bent, etc. and can be changed into any other shape, whether crumpled, bent on itself, as was done with Label 1, wrinkled, coupled to thin wire as a tag, to a corrugated surface, or put into any other irregular shape.

Several possible approaches to determine that the quality of the one or more captured digital images is sufficient, including measuring focus, determining the quality of object character recognition (OCR) on the vintner's name, and other such approaches. While digital image data is continuously captured, the data can be analyzed in real-time to determine if the quality of that data is adequate for use to determine a type of wine and to serialize the wine bottle, and, if the data is inadequate, a computer-based application may automatically re-take one or more digital images, or a user may be instructed to do so. In at least one embodiment, an audio file may instruct, for example, “Take a photo of the vintner's name on the label including the top edge of the label in your photo.”

After successfully processing the anchor digital image data, the user or computer-based application may query the repository (e.g., database) to determine certain parameters associated with the authentication region (e.g., the offset to the authentication region, the size of the authentication region, the orientation of the authentication region, and other parameters). The parameters associated with the authentication region may be provided, for example, in the form of a template associated with a class of objects whose anchor regions match those in the anchor digital image data. If the anchor digital image data does not have the authentication region in view, the system can instruct the user to capture at least one digital image of both the vintner's name and the area of the label around the vintner's name at the same time. When the one or more digital images are captured, and when the vintner's name is sufficiently clear, the authentication region may optionally be isolated by a template. After the optional isolation of the authentication region, feature vectors are extracted and generated, and one or more digital fingerprints are compared with data in various records of the reference repository (e.g., database) to determine the authenticity of the bottle of wine. Because both the name and the authentication region are at the same part of the curve of the bottle, if one of the name and the authentication region is correctly imaged, so is the other. Just as there can be more than one anchor region, which may be used in concert or separately, there can also be more than one authentication region. In at least one embodiment, a first authentication region is located on the wine bottle label and a second authentication region is located on the wine bottle capsule.

In this example of FIGS. 1 and 2, all parts of the Label 2 underwent the same distortion. The authentication region underwent the very same distortion as the anchor region, and the distortion is therefore the same for both regions, relative to each other. When comparing the data in the regions, or otherwise processing the image data, the location of the authentication region relative to the determined information about the anchor region, will yield the same relative relationship that was present in the flat label.

Another illustrative example relates to the authentication of identity documents. When authenticating a passport or other identity card, for example, it is insufficient to simply find an area on the physical object (i.e., the identity document) that successfully authenticates. It is insufficient, for example, to authenticate the whole document by simply authenticating a region of the background because such singular authentication is not sufficient to ascertain that an original photograph has not been replaced by another. A passport, for example, is only legitimate when a plurality of determined regions (e.g., photograph, background, signature, serial number, place and date of issue) are authenticated separately, shown to match the original, and when the plurality of authenticated areas are also located in a specified physical relationship to each other. To achieve complete authentication of the identity document, therefore, the authentication system, device, and method should adequately capture sufficiently clear digital images of all of the determined regions, apply a properly scaled and oriented template to the digital images, and authenticate the regions both individually and as a group. With a handheld imaging device (e.g., smartphone, wearable computer, tablet computer, or the like), it might be difficult to properly align and set the distance for the imaging means without help.

The following example, which uses the teachings of this disclosure to authenticate a passport, is now described. At authentication, the entire photo page of the passport was adequately captured in one or more digital images using, for example, a high-resolution scanner. The serial number of the passport was set as the anchor region, and one or more resolution requirements for that anchor region were determined. A template was created containing the anchor region (e.g., the serial number) and the authentication regions (e.g., the photo, the signature, the expiration date, and the serial number). Also determined were the criteria that a user, a computer-based application, or a user cooperating with a computer-based application will later use to determine whether one or more digital images of the anchor region are adequately captured. These criteria might include, for example, whether the serial number or other text on the purported passport document can be read with OCR, whether there are, for example, ten (10) pixels across the average stroke, or by many other means. Once the authentication regions are templated, authentication feature vectors are extracted, and all relevant data (e.g., the template, the feature vectors, the serial number, and possibly other recognized text) are added to a record in a reference repository (e.g., database). The size and orientation of the anchor region data is also captured in at least one digital image to enable scale and rotation corrections to be made at authentication.

Later, after the passport has been in possession and use of its owner, one or more digital images of the same page of the passport are captured.

Because the entire page is imaged, there is no need in this embodiment to instruct the user regarding details (e.g., location, size, orientation, and the like) of the anchor region or authentication region. If necessary, the user or the computer-based application finds the anchor region and changes parameters (e.g., scale, orientation, illumination, focus, and the like) of the scanning means to meet the specified requirements to adequately capture digital images. The template is applied, and the authentication regions are found. Any suitable number of feature vectors are extracted from the authentication regions and compared to data in one or more records of the repository (e.g., database). A result is returned.

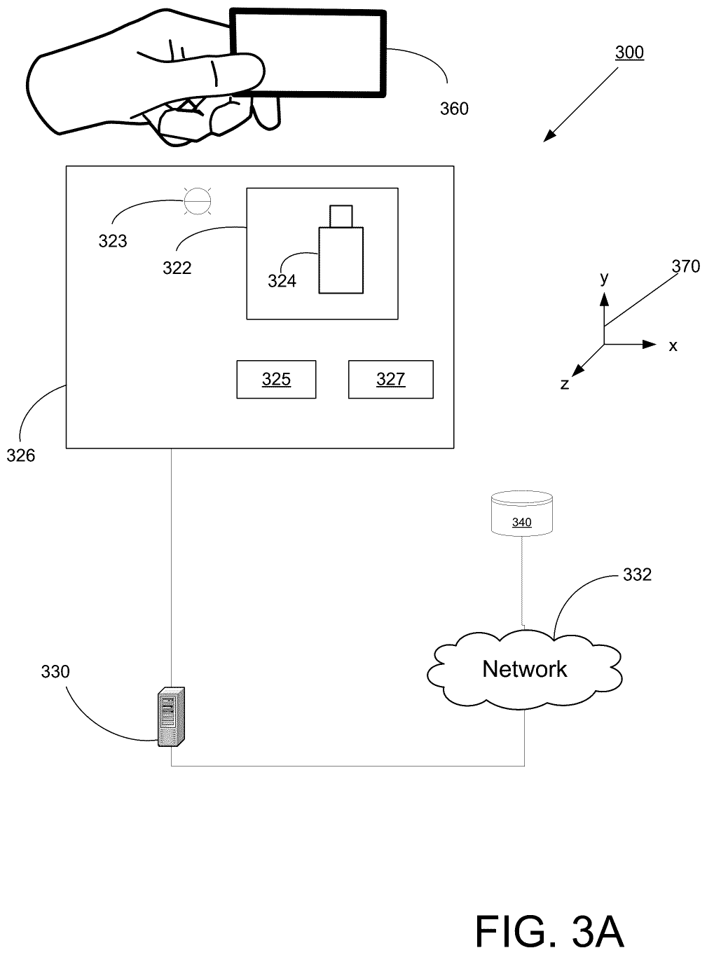

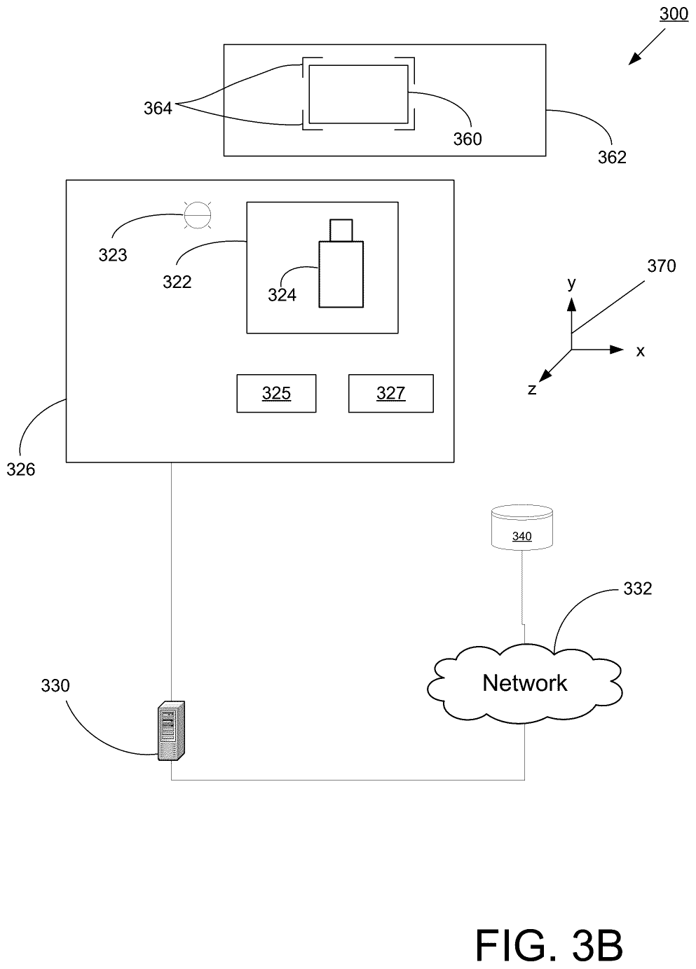

FIGS. 3A and 3B are schematic diagrams of a digital fingerprint system 300 for inducting a physical object 360 and/or authentication regions of the physical object 360 into a digital fingerprint repository 340 via an induction/authentication system 326 and/or for authenticating a physical object that has been inducted into a digital fingerprint system 300. In an implementation shown in FIG. 3A, the physical object 360 can be held by a user in relation to the induction/authentication system 326. In an implementation shown in FIG. 3B, the physical object 360 can be positioned on a stage 362 in relation to the induction/authentication system 326. In some cases, the digital fingerprint repository is arranged as a local database. In other cases, the digital fingerprint repository is arranged as a remote database system 340. The digital fingerprint repository 340 can include a processor and a data store, and the digital fingerprint repository, via the processor, may be interrogated, queried, loaded, updated, or otherwise interacted with using any acceptable protocol such as structured query language.

Digital repository records of the digital fingerprint repository 340 are accessible via a computing system (e.g., a computing server or other computing device), wherein information (e.g., digital fingerprints, characterization data, authentication region data, testing protocol data, provenance data, authentication data, feature data, certificate data, most recent authentication data, transaction history data, and other such data), is passed via a network 332 (e.g., a local area network (LAN), a wide area network (WAN) such as the Internet, or some other network).

The induction/authentication system 326 is configured for rapidly inducting an object into the digital fingerprint system 300 and/or for rapidly authenticating an object that has been inducted into the system 300 by continuously capturing a plurality of digital images of the object. As the plurality of digital images is captured, each image is analyzed to determine if the image is of sufficient quality for induction or authentication, and this analysis is performed in real-time, for example, within one second, or within 0.5 seconds, or within 0.25 seconds of the capture of the image. The object then is inducted or authenticated, based on digital image data from one or more of the captured digital images that has been determined to be of sufficient quality of induction or authentication. In some implementations, the induction or authentication occurs in real-time, for example, within one second, or within 0.5 seconds, or within 0.25 seconds of the capture of the one or more digital images determined to be of sufficient quality for use in the induction or authentication of the object.

The induction/authentication system 326 can include memory 325 storing computer-executable instructions that are executed by one or more processors 327 configured for executing the instructions to perform techniques and functionality described herein. In some implementations, the computer-executable instructions can include instructions for interpreting digital image data to determine that a predetermined type of object exists in the digital image data. For example, the digital fingerprint system 300 can maintain a database of a number of types of different objects and characteristic digital image data that identify the types of objects (e.g., a shape of the objects, text in the digital image data, colors of the object, etc.). In addition, the computer-executable instructions can include instructions for interpreting digital image data of authentication regions objects and for generating digital fingerprints for an object from the digital image data in the authentication regions of a digital image of the object. For example, the digital fingerprint system 300 can maintain a database of digital fingerprints for different objects that uniquely identify the objects.

The induction/authentication system 326 can include a light source 323 configured for illuminating the physical object 360 and a scanner 322 for capturing digital images of the physical object 360. The scanner 322 includes a camera 324 that may be arranged to scan portions of the physical object 360 to capture a series of digital images including digital image data of one or more anchor regions and of one or more authentication regions. In some implementations, the scanner 322 continuously captures digital images of the physical object 360 at a regular rate, where the regular rate can be, for example 24 images per second, 30 frames per second, 60 frames per second. The camera 324 can include one or more optical elements (e.g., lenses) configured for imaging light received from the physical object and an image sensor configured for detecting the imaged light. In some implementations, the optical elements can be controlled to vary an optical property of the camera 324. For example, the optical elements can be controlled to vary a focus position or focal plane of the camera. The scanner 322 can capture digital images, at a predetermined rate, for example, at a rate of greater than or equal to 12 Hz, greater than or equal to 24 Hz, greater than or equal to 30 Hz, greater than or equal to 60 Hz, or at a higher rate.

A number of different types of objects can be scanned by the scanner 322, and anchor regions in images of the different types of objects can be identified (either manually or automatically, e.g., using machine vision or machine learning techniques) in the digital image data captured by the scanner, where the anchor regions can be used to identify the different types of objects. Anchor regions can include, for example, text, lines, curves, shapes, and other features that are characteristic of a type of object but that distinguish other types of objects. In some implementations, a single image of an object type captured by the scanner 322 can be used to define anchor regions for the object type. In some implementations, multiple images of a type of object can be captured by the scanner 322 and can be used to define anchor regions for the object type.

In addition, authentication regions for different object types can be identified in the digital image data captured by the scanner 322, where the digital image data in the authentication regions can be used to generate digital fingerprints for the objects. In some implementations, a single image of an object of an object type captured by the scanner 322 can be used to define authentication regions for the object type. In some implementations, multiple images of an object of a type of object can be captured by the scanner 322 and used to define authentication regions for the object type.

Images used to define anchor regions and authentication regions for types of objects can be generated from scans of the objects when the objects are located in fixed positions and orientations with respect to the camera 324 of the scanner, under particular lighting conditions (e.g., amount and direction of light), and under particular imaging conditions (e.g., focus of the image, magnification of the image, etc.).

After anchor regions and authentications regions for one or more types of objects are defined, objects of various types can be inducted into the system 300 by scanning the objects with the scanner 322 to generate digital image data and processing the digital image data to generate a digital fingerprint for objects that are scanned.

In some implementations, a proprietor or other user may possess a physical object 360. The physical object 360 may include, for example, a product container (e.g., a wine bottle as shown in FIGS. 1-2), product packaging (e.g., a label of a product, such as the label of the wine bottle as shown in FIGS. 1-2), the object itself (e.g., a passport), or any other physical object. As part of the induction process, the induction/authentication system 326 may then process the captured digital image data to determine the quality of the digital image data, determine a type of object that has been scanned, extract one or more authentication regions from the digital image data, generate a digital fingerprint that uniquely identifies (e.g., serializes) the physical object based on the digital image data, and/or authenticate a physical object using the one or more authentication regions and/or the digital fingerprint.

The induction/authentication system 326 may use the digital image data of the authentication regions captured from the physical object 360 to serialize the physical object, by, for example, forming a digital fingerprint that uniquely identifies the physical object 360 and/or matching one or more authentication regions and/or digital fingerprints from currently captured digital image data with a reference authentication region and/or digital fingerprint stored in, for example, the digital fingerprint repository on the database system 340.

The scanner 322 and/or the induction/authentication system 326 may be integrated into, or connected to, a proprietor system 330. The proprietor system 330 may be any user device, for example, a smartphone or other mobile device, a tablet, a personal computer, a laptop computer, a computer server, a cloud computing system, and the like. In examples where the proprietor system 330 is a mobile device, the mobile device may be a smartphone having an integrated scanner 322 (e.g., a built-in camera 324), a processor, memory, and network connectivity ability for executing one or more instances of the induction/authentication system 326 implemented in, for example, one or more clients, applications of other software systems.

The physical object 360 can be positioned relative to the camera 324 in a three-dimensional space. For example, within three-dimensional coordinate system 370, the physical object 360 can have a distance from the camera 324 in the x-direction, the y-direction and the z-direction and can have an orientation relative to the camera 324 at angles relative to the x-direction, the y-direction and the z-direction in the three-dimensional coordinate system 370. Thus, the physical object 360 can be positioned, or moved, in six degrees of freedom (6DoF) relative to the camera 324. In other words, the physical object 360 can have an up/down distance, a left/right distance, a forward/backward distance, and a pitch angle, a yaw angle, and a roll angle relative to the camera 324. In some implementations, the physical object 360 can be held by a user and can be moved by the user. In some implementations, the physical object 360 can be positioned on a stage 362 (e.g., a fixed-position platform, a conveyor belt that moves the physical object 360 past the scanner 322, or a mount that moves the physical object in one or more degrees of freedom).

In some implementations, a user can move the physical object 360 within the three-dimensional coordinate system 370 to position the physical object 360 relative to the camera 324 while a series of digital images of the physical object 360 are captured by this scanner 322. In some implementations, a focal position of the camera 324 of the scanner can be varied while the series of digital images of the physical object 360 are captured by this scanner 322. In some implementations, a position, or point of view, of the camera 324 can be varied while the series of digital images of the physical object 360 are captured by the scanner 322.

The digital images can be continuously captured at a predetermined rate, for example, at a rate of greater than or equal to 12 Hz, greater than or equal to 24 Hz, greater than or equal to 30 Hz, greater than or equal to 60 Hz, or at a higher rate. The physical object 360 can be moved manually or through automated techniques (e.g., by moving the physical object on a conveyor belt, by a robot, etc.) while digital images are captured by the scanner. In addition, the camera 324 can be moved relative to the physical object 360 within the three-dimensional coordinate system 370 while digital images are continuously captured by the scanner. For example, the camera 324 can be connected to a mount that can move the camera in one or more degrees of freedom (e.g., six degrees of freedom) relative to the physical object 360. Furthermore, illumination light from the light source 323 and the focal position of the camera 324 can be varied while digital images are captured by the scanner.

In some implementations, a default, or predetermined, position of the physical object 360 relative to the camera 324 can be defined in the three-dimensional coordinate system 370, where the default, or predetermined, position is selected to enable the capture of digital images of the physical object that will result in digital image data of the object being of sufficient quality to enable the reliable and accurate determination of an object type of the physical object and a unique digital fingerprint of the physical object. In some implementations, the system 300 can include a platform upon which the physical object 360 can be positioned relative to the camera 324. In some implementations, the platform can include one or more indicia 364 (e.g., lines, arrows, points, etc.) to assist in positioning the physical object 360 relative to the camera for optimal imaging of the physical object. In some examples, the indica can assist in positioning the physical object 360 at, or close to, the default, or predetermined, position.

In some implementations, the relative position and/or orientation of the physical object 360 and the camera 324 can be varied while a series of digital images of the physical object is continuously captured by the scanner 322. The digital image data of each captured digital image can be analyzed in real-time, for example, within one second, or within 0.5 seconds, or within 0.25 seconds of the capture of the image, (e.g., by a processor 327 of the induction/authentication system 326, a processor of the proprietor system 330, and/or a processor of the database system 340) as the series of digital images is continuously captured to determine if the captured digital image is of sufficient quality to determine the class, or type, of the object and to generate a digital fingerprint of the physical object. By continuously capturing a series of digital images of the physical object as parameters related to quality metrics of the digital images are varied, and by analyzing the quality metrics of each digital image in real-time, the system 326 can immediately determine when a digital image, which is of sufficient quality for induction or authentication of the physical object, is captured for each object. Once a determination is made that such an image of sufficient quality has been captured, then, as explained in more detail below, feedback can be provided to a user or to the system regarding this determination, so that a next object can be scanned. Furthermore, if a user or the system does not receive such feedback as the item it being continuously scanned, the user or the system can continue scanning the object while parameters related to the quality metrics are varied until an image of sufficient quality is scanned.

In some implementations, a digital fingerprint for the physical object can be generated in real-time from digital image data captured from the physical object, while a plurality of digital images of the object are captured In some implementations, a digital fingerprint for the physical object can be generated some time after the digital image data is captured from the physical object.

In one implementation, when a captured digital image of the physical object contains digital image data that satisfies one or more predetermined quality metric thresholds, the digital image data of that digital image can be processed to determine the class, or type, of the object and to generate a digital fingerprint of the physical object In one implementation, when a plurality of captured digital images of the physical object contain digital image data that satisfies one or more predetermined quality metric thresholds, digital image data of a digital image having one or more highest quality metrics can be used to determine the class, or type, of the object and to generate a digital fingerprint of the physical object. For example, a total quality metric can be determined for each digital image based on the individual quality metrics determined for the digital image, and the total quality metric can serve to evaluate the suitability of different digital images for generating a digital fingerprint of the physical object. In some implementations, the total quality metric can be a weighted average of individual quantitative quality metrics for a digital image, and a digital image having the highest total quality metric can be used to generate the digital fingerprint for the physical object. Thus, in some implementations, when a plurality of digital images of a physical object are captured, and many or all of the digital images satisfy one or more predetermined quality metric thresholds, the “best” digital image of the physical object, which has the highest total quality score, can be used to generate the digital fingerprint for the physical object. In some implementations, only digital images whose individual quality metrics all satisfy their respective quality metric thresholds can be considered for use in generating the digital fingerprint for the physical object.

In some implementations, when a captured digital image of the physical object contains digital image data that satisfies one or more predetermined quality metric thresholds, one or more indications (e.g., visual indications, audible indications, tactile indications, etc.) can be provided to a user, so that the scanning of the object can be stopped, and, for example, scanning of a next physical object can be commenced to induct the next physical object into the database system 340. In some implementations, for example, when the physical object is one of many objects moving past the camera 324 on a conveyor belt, when a captured digital image of the physical object contains digital image data that does not satisfy one or more predetermined quality metric thresholds, one or more indications can be provided to a user and/or the physical object can be flagged (e.g., physically or digitally) to indicate that the physical object has not been inducted into the database system 340 and will need to be re-scanned.

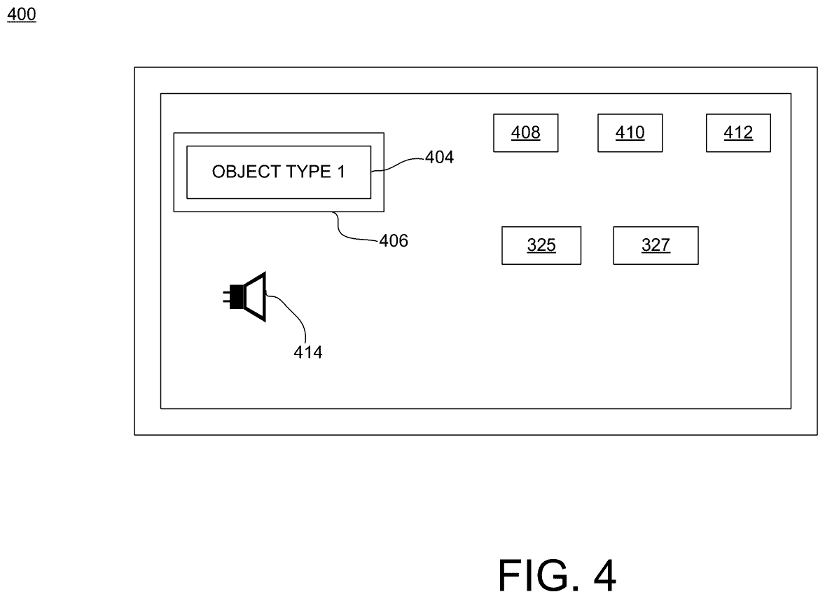

FIG. 4 is a schematic diagram of an example system 400 for providing feedback regarding the quality of image data that is captured by the system 326. The system 400 can be part of the induction/authentication system 326 and can include the processor 327 and the memory 325. The system 400 can include a first user interface element 404 and a second user interface element 406 that can provide feedback regarding the quality of digital image data that is used to define a type of object that is inducted into the digital fingerprint system 300. In some implementations, the first user interface element 404 can include a display that is configured to display a name of an object type that is present in a digital image scan by the induction/authentication system 326. For example, when a digital image is scanned from a physical object, where the digital image includes elements that match an object type that has been defined in the database 340 of the digital fingerprint system 300, the first user interface element 404 can display the name of the object type.

For example, when digital image data has been captured to define anchor regions and templates for a number of different object types (e.g., a first type of wine, a second type of wine, a third type of wine, etc.) and the templates have been stored in the database 340, then when an object is presented to the induction/authentication system 326 and a digital image of the object is captured, if the digital image data includes features that match the anchor regions for a particular object type that has been stored in the database 340, the system 400 can cause the first user interface element 404 to display the name of the object type.

In some implementations, when an object is presented to the induction/authentication system 326 and a digital image of the object is captured, if the digital image data does not include features that match the anchor regions for any object type that has been stored in the database come on the system 400 can cause the first user interface element to remain blank or to display an indication (e.g., “NO OBJECT TYPE FOUND”) that a stored object type has not been identified.

In some implementations, when an object is presented to the induction/authentication system 326 and a digital image of the object is captured, one or more quality metrics associated with the captured digital image can be determined and evaluated to determine whether the captured digital image is of sufficient quality to determine whether the object matches a particular object type that has been stored in the database 340. For example, to reliably evaluate digital image data to determine whether the presented object matches data of a stored object type, the digital image captured from the presented object may need to satisfy one or more threshold quality metrics.

For example, the presented object may need to be located within a particular range of distances from the camera of the scanner, to be illuminated with a particular brightness and contrast, and the image may need to have a predetermined focus for the image to provide sufficient digital image data to be used for a reliable determination of the object type. When a presented object is detected in the field of view of the camera, but one or more quality metrics of an image of the presented object fail to satisfy their threshold criteria, a second user interface element 406 can indicate that an object has been detected by the induction/authentication system 326 but that images of the object are of insufficient quality to determine a type of the presented object. In some implementations, the second user interface element 406 can include a light-emitting border around the first user interface element 404 to indicate whether images of the presented object are of sufficient quality to determine a type of the presented object. For example, the second user interface element 406 can emit white light when an object is detected in the field of view of the camera, but one or more quality metrics of an image of the presented object fail to satisfy their threshold criteria and can emit green light when the requisite quality metrics for the image of the object are satisfied. In some implementations, the quality metrics can be defined in relation to quality metrics of images of the object types that were used to define the anchor regions and templates for the object types that are stored in the database 340. For example, when images of the object types that were used to define the anchor regions and templates for the object types are captured with the objects being located within a particular range of distances from the camera and with the images being captured with a particular range of resolutions, then the range of distances and resolutions can be used as a references to determine quality metrics for an image of a test object that is presented to the induction/authentication system 326 for induction.

In some implementations, the system 400 can include a third user interface element 408, a fourth user interface element 410, and a fifth user interface element 412, which can indicate whether individual quality metrics of a digital image captured from the presented object satisfy a threshold value. For example, the third user interface element 408 can indicate (e.g., by changing color, brightness, etc.) whether the presented object is located within a required range of distances from the scanner, the fourth user interface element 410 can indicate whether the illumination of the presented object satisfies an illumination metric, and the fifth user interface element 412 can indicate whether a noise level of the image satisfies a noise metric. In some implementations, the system 400 can include a sixth user interface element 414 that can indicate whether a digital image of a physical object is of sufficient quality to generate a digital fingerprint that can be used to induct or authenticate the object. For example, the sixth user interface element 414 can include a speaker that can emit audible sound(s) to indicate when a digital image of a physical object has been scanned, which is of sufficient quality to generate a digital fingerprint. For example, the sound can include a chime, buzz, or ding sound or one or more spoken words (e.g., “Scan Complete”) to indicate that a digital image of a physical object has been scanned, which is of sufficient quality to generate a digital fingerprint for the object.

With feedback from the individual elements 408, 410, 412 and repeated scanning of the presented object, a user may gain an understanding of which image quality metrics need to be improved so that an object type for a presented object can be determined.

With an object type for the presented object having been determined, additional images of the presented object can be captured and image quality metrics can be determined and used to determine whether the additional images are of sufficient quality for generating a digital fingerprint of the presented object from one or more of the additional captured images. In some implementations, the image quality metrics can include one or more of the following: distance between the camera 324 and the presented object, a focus quality or the presence of motion blur of an image, an illumination of the object, a rotation of the object relative to the camera, and a noise level in the image. Each additional digital image of the presented object can be analyzed in real-time, for example, within one second, or within 0.5 seconds, or within 0.25 seconds of the capture of the image, as the additional digital images are continuously captured, to determine if the captured digital image is of sufficient quality to generate a digital fingerprint of the physical object or to authenticate the object based on the digital fingerprint.

For example, a distance quality metric can be determined for each digital image by measuring a distance of the object from the camera and comparing the measured distance with an expected distance of the object from the camera. The distance of the object from the camera can be measured in a number of different ways, for example, using a LIDAR system, with stereo vision techniques, by using an autofocus lens to determine an optimal focal point of the lens on a surface of the object, etc. In some implementations, an expected feature size of features used for determining a digital fingerprint can be used to determine a distance of the object from the camera. For example, if, when an object of a particular object type is located at an expected distance from the camera, the features have a size, X, in an image of the object, then a difference in the feature size from the size, X, can be used as a proxy to determine a distance of the object from the expected distance. For example, if the observed feature size is less than X, the object can be determined to be located farther away from the camera than the expected distance, and if the observed feature size is greater than X, the object can be determined to be located closer to the camera than the expected distance. For a particular object type, authentication regions of an object may need to be located within a predetermined range of distances to satisfy a distance quality metric.

In another example, a focus quality metric for an image can be determined by a number of methods including, for example, measuring a variance of the Laplacian for the image or by performing an edge detection algorithm on the image and computing the number of pixels located in detected edges, adding artificial blur to the image and subtracting it from itself, etc. For a particular object type, the focus quality metric(s) for authentication regions in an image of the object may need to satisfy one or more threshold requirements to satisfy a focus quality metric.

In another example, an illumination quality metric for an image can be determined by a number of methods including measuring statistics on number of bright and dark pixels in the image. For a particular object type, the illumination metric for an image of the authentication regions in an object may need to satisfy one or more threshold requirements to satisfy an illumination quality metric.

In another example, a rotation quality metric for an image can be determined by a number of methods including determining a rotational transformation to perform on the image in order to align the transformed image with a reference image. For some objects, a rotational transformation of an image can align the image with the reference image, such that a close match between the rotated image and the reference image can be determined. In such cases, the threshold for a rotation quality metric can be relatively relaxed. However, for other objects, such as three-dimensional images, an object that is rotated from its reference orientation might have its authentication regions located at different distances than their expected distances when the object is aligned in its reference orientation. Also, for objects that are illuminated with a non-isotropic illumination pattern, an object that is rotated from its reference orientation might have its authentication regions illuminated differently than when the object is aligned in its reference orientation, making comparison of a rotated image with a reference image difficult. In such cases, the threshold for a rotation quality metric can be relatively stringent, to ensure that the object is aligned properly to capture image data of sufficient quality to enable the generation of a digital fingerprint for the object.

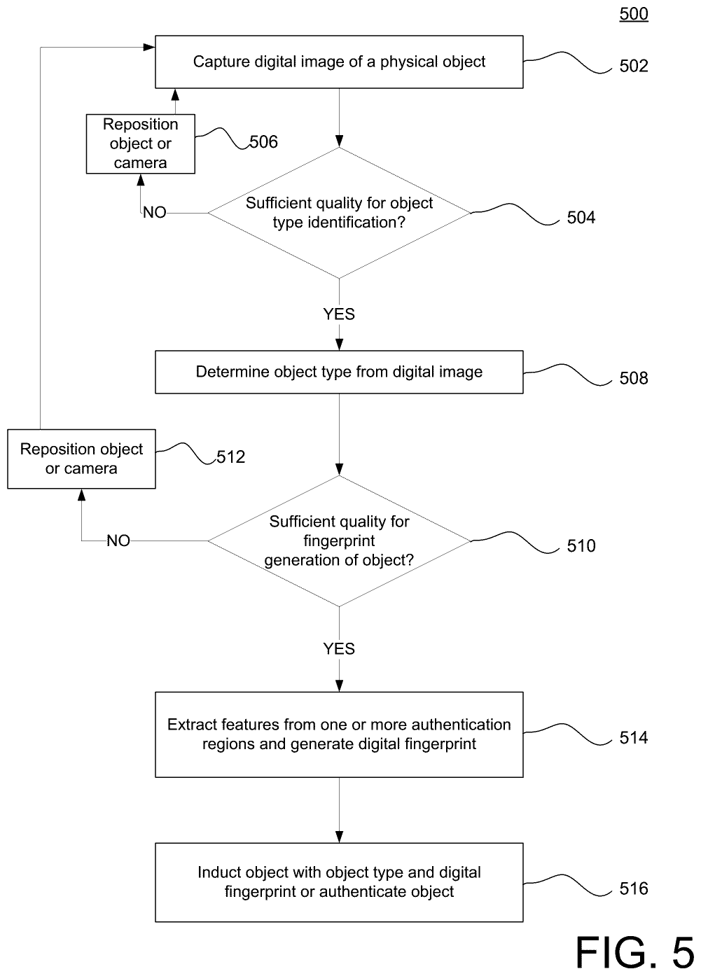

FIG. 5 is a flowchart of an exemplary process 500 for inducting a physical object into a database of a digital fingerprint system. At 502, the scanner may continuously capture digital images of the physical object, where the digital images include digital image data of one or more portions of a physical object. The digital image data may include one or more portions of the physical object having an anchor region. An anchor region may include, for example, a label, packaging, or a container, of a product or other area of the physical object used to identify the object. At 504, the quality of the captured digital image data from a captured digital may be determined based on one or more quality metrics as described above. A level of image quality for the digital image data may be determined by comparing the one or more metrics to a predetermined threshold. While the determined quality is insufficient to determine an object type from the digital image data, digital images of the physical object can continue to be captured at 502. In some implementations, the object and the camera can be repositioned relative to each other at 506 before, or while, another digital image of the physical object is captured at 502.

If the quality is sufficient to determine an object type from the digital image data, the object type is determined at 508. At 510, the quality of the captured digital image data from a captured digital may be determined based on one or more quality metrics as described above. While the determined quality is insufficient to generate a digital fingerprint from the digital image data, digital images of the physical object can continue to be captured at 502. In some implementations, the object and the camera can be repositioned relative to each other at 512 before, or while, another digital image of the physical object is captured at 502. If the quality is sufficient to generate a digital fingerprint from the digital image data, the digital fingerprint is determined at 514, and the object is inducted with the determined object type and the digital fingerprint at 516.

### Additional Considerations

The systems, methods, and devices (i.e., the teaching) of the present disclosure can be distinguished from both ordinary templating and from the use of registration marks. Templating, as the term is used herein, informs a human user or computer-based application where relevant data may be extracted from one or more digital images. Registration marks merely show a user how to align and scale the imaged region, or how to clip a larger image. Neither ordinary templating nor registration marks teach the specific component of using one region, for which it is easy to determine whether the region is adequately captured, to ensure with acceptable confidence that another region, which may or may not be distinguishable by the naked eye in any way, is adequately captured.

In the embodiments taught herein, there may be one or more anchor regions, one or more authentication regions, or both on a physical object. There may or may not be feedback to a user or to a computer-based application as to whether the anchor region and the authentication region are all in view. Feedback is not needed, for example, in cases where the anchor region is in fact also the authentication region.

Many different means for determining that the anchor region is adequately captured are taught and still others are contemplated. Several methods suggest themselves, among which are a resolution pattern that is focused until a certain resolution is found, a bar code (e.g., a UPC code) is imaged such that the bar code is both readable and has a certain number of pixels across a stroke, a logo where features within the logo are resolved, and a label (e.g., an “AUTHENTICATED BY ALITHEON” or other label) is formed in type sufficiently small that, if it is readable, authentication is highly likely to work.

Several different methods of capturing digital images and making use of one or both of the anchor regions and the authentication regions of interest are taught and still others are contemplated. Whatever system, device, or method is used to capture digital images and process the one or more anchor regions, providing good results are achieved, then those systems, devices, and methods should also be capable of adequately capturing the one or more authentication regions of interest or providing the user or a computer-based application with a means for also adequately capturing the one or more authentication regions of interest for authentication to be performed.

Any suitable type of authentication can be used SIFT, SURF, and numerous others will work well.

Once a suitable digital fingerprint of an object is generated, the digital fingerprint may be stored or “registered” in a repository such as a database. For example, in some embodiments, the digital fingerprint may comprise one or more unique features, which are stored as feature vectors. The repository should be secure. In some embodiments, a unique identifier (ID) such as a serial number also may be assigned to an object. An ID may be a convenient index in some applications. However, such an ID is not essential, as a digital fingerprint itself can serve as a key for searching a repository. In other words, by identifying an object by the unique features and characteristics of the object itself, identifiers, labels, tags, etc., become unnecessary to an authentication of the object.

Because in many of the cases described herein features are extracted from images produced under variable lighting conditions, it is unlikely to a determined and acceptable statistical certainty (e.g., less than 20% chance, less than 1% chance, less than 0.01% chance, less than (1×10⁻¹⁰)) chance, or some other value) that two different “reads” will produce the exact same digital fingerprint. In a preferred embodiment, the system is arranged to look up and match items in the database when there is a “near miss.” For example, two feature vectors, [0, 1, 5, 5, 6, 8] and [0, 1, 6, 5, 6, 8], are not identical, but by applying an appropriate difference metric, the system can determine that the two feature vectors are close enough to confirm to an acceptable level of certainty that they are from the same item that has been digitally fingerprinted or inducted before. One example is to calculate Euclidean distance between the two vectors in multi-dimensional space and compare the result to a threshold value. This is similar to the analysis of human fingerprints. Each fingerprint taken is slightly different, but the identification of key features allows a statistical match with an acceptably high degree of certainty.

### Hardware and Software

At least some of the structures (e.g., devices, apparatus, systems and the like) discussed herein comprise electronic circuits and other hardware along with associated software. For example, a conventional portable device (e.g., mobile phone, smartphone, tablet, wearable computer, Internet of Things (“IOT”) device, and other such computing devices) is likely to include one or more processors and software executable on those processors to carry out the operations described. The term software is used herein in its commonly understood sense to refer to programs or routines (e.g., subroutines, objects, plugins, etc.), as well as data, usable by a machine or processor. As is well known, computer programs generally comprise instructions that are stored in tangible, non-transitory machine-readable or computer-readable, storage media. Some embodiments of the present disclosure may include executable programs or instructions that are stored in machine-readable or computer-readable storage media, such as a digital memory. One of skill in the art will recognize that a computer, in the conventional sense, is not required in any particular embodiment. For example, various processors, embedded or otherwise, may be used in equipment taught in the present disclosure.

Memory for storing software is well known. In some embodiments, memory associated with a given processor may be stored in the same physical device as the processor (i.e., on-board memory); for example, RAM or FLASH memory disposed within an integrated circuit microprocessor or the like. In other examples, the memory comprises an independent device, such as an external disk drive, storage array, or portable FLASH key fob. In such cases, the memory becomes associated with the digital processor when the two are operatively coupled together, or in communication with each other, for example by an I/O port, a communication bus, network connection, etc., such that the processor can read information (e.g., a file) stored on the memory. Associated memory may be read-only memory by design (ROM) or by virtue of permission settings, or not. Other examples include, but are not limited to, WORM, EPROM, EEPROM, FLASH, etc. Those technologies often are implemented in solid state semiconductor devices such as integrated circuits. Other memories may comprise moving parts, such as a conventional rotating disk drive. All such memories are machine readable, computer-readable, or another like term, and all such memories may be used to store executable instructions for implementing one or more functions described herein.

A software product refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. Those of ordinary skill in the art recognize that software can be distributed via electronic transmission (e.g., download), in which case there will at least sometimes be a corresponding software product at the transmitting end of the transmission, the receiving end of the transmission, or both the transmitting and receiving ends of the transmission.

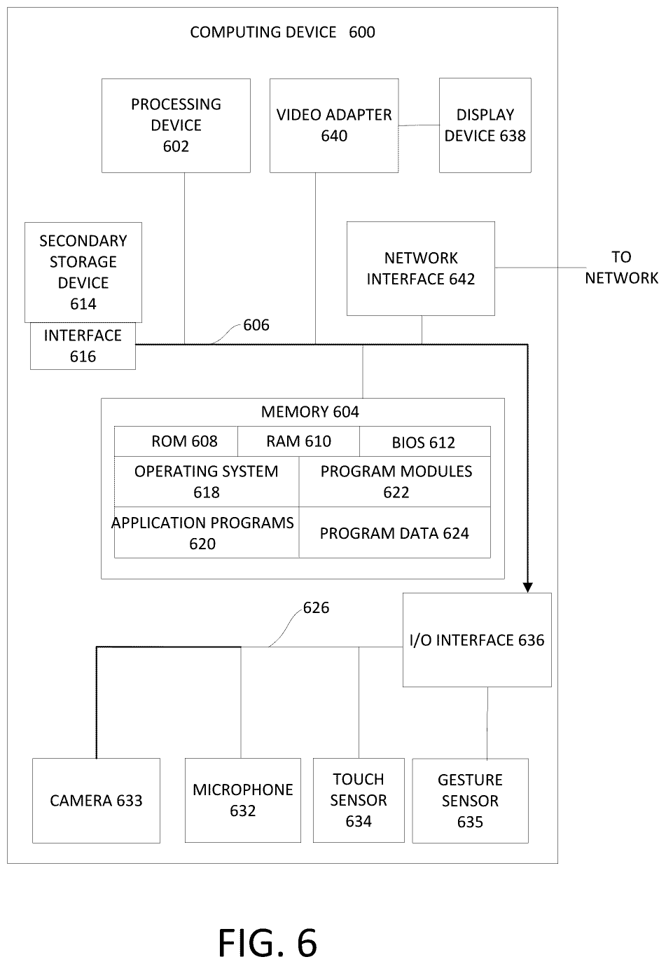

FIG. 6 illustrates an example architecture of a computing system 600 that can be used to implement aspects of the present disclosure, including any of the systems, apparatuses, and/or techniques described herein, or any other systems, apparatuses, and/or techniques that may be utilized in the various possible embodiments.

The computing system illustrated in FIG. 6 can be used to execute the operating system, application programs, firmware modules, and/or software modules described herein.

The computing system 600 includes, in some embodiments, at least one processing device 602 (e.g., a processor), such as a central processing unit (CPU). In this example, the computing system 600 also includes a system memory 604, and a system bus 606 that couples various system components including the system memory 604 to the processing device 602. The system bus 606 is one of any number of types of bus structures that can be used, including, but not limited to, a memory bus, or memory controller; and a local bus using any of a variety of bus architectures.

The system memory 604 includes read only memory 608 and random access memory 610. A basic input/output system 612 containing the basic routines that act to transfer information within computing system 600, such as during start up, can be stored in the read only memory 608.

The computing system 600 also includes a secondary storage device 614 in some embodiments, such as a flash drive, for storing digital data. The secondary storage device 614 is connected to the system bus 606 by a secondary storage interface 616. The secondary storage device 614 and its associated computer readable media provide non-volatile and non-transitory storage of computer readable instructions (including application programs and program modules), data structures, and other data for the computing system 600.

Although the example environment described herein employs a flash drive as a secondary storage device, other types of computer readable storage media are used in other embodiments. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 614 and/or system memory 604, including an operating system 618, one or more application programs 620, other program modules 622 (such as the software engines described herein), and program data 624. The computing system 600 can utilize any suitable operating system, such as Microsoft Windows™, Google Chrome™ OS, Android, or Linux and variants and any other operating system suitable for a computing system.

In some embodiments, a user provides inputs to the computing system 600 through one or more input devices 626. Examples of input devices 626 include a microphone 632 (e.g., for voice and/or other audio input), a touch sensor 634 (such as a touchscreen or touch sensitive display), and gesture sensor 635 (e.g., for gestural input), and a camera 633 (e.g., for capturing digital images of physical objects). Other embodiments include other input devices 626. The input devices can be connected to the processing device 602 through an input/output interface 636 that is coupled to the system bus 606. These input devices 626 can be connected by any number of input/output interfaces, such as a parallel port, serial port, game port, or a universal serial bus.

In this example embodiment, a display device 638, such as a liquid crystal display device, light-emitting diode display device, or touch sensitive display device, is also connected to the system bus 606 via an interface, such as a video adapter 640.

The computing system 600 can be connected to one or more networks through a network interface 642. The network interface 642 can provide for wired and/or wireless communication. In some implementations, the network interface 642 can include one or more antennas for transmitting and/or receiving wireless signals. When used in a local area networking environment or a wide area networking environment (such as the Internet), the network interface 642 can include an Ethernet interface. Other possible embodiments use other communication devices. For example, some embodiments of the computing system 600 include a modem for communicating across the network. Wireless communication between the computing system 600 and other network-connected devices can occur over BLUETOOTH® wireless technology, 802.11a/b/g/n, cellular, ultra-wideband (UWB), ZigBee, or other radio frequency communication systems in some possible embodiments, to name just a few examples.

The computing system 600 can include at least some form of computer readable media. Computer readable media includes any available media that can be accessed by the computing system 600. By way of example, computer readable media include computer readable storage media and computer readable communication media.

Computer readable storage media includes volatile and non-volatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, or any other medium that can be used to store the desired information and that can be accessed by the computing system 600.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing system illustrated in FIG. 6 is also an example of programmable electronics, which may include one or more such computing devices, and when multiple computing devices are included, such computing devices can be coupled together with a suitable data communication network so as to collectively perform the various functions, methods, or operations disclosed herein.

Unless defined otherwise, the technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

The singular forms “a,” “an,” and “the” in the present disclosure include plural referents unless the content and context clearly dictates otherwise. The conjunctive terms, “and” and “or” are generally employed in the broadest sense to include “and/or” unless the content and context clearly dictates inclusivity or exclusivity as the case may be. The composition of “and” and “or” when recited herein as “and/or” encompasses an embodiment that includes all of the elements associated thereto and at least one more alternative embodiment that includes fewer than all of the elements associated thereto.

The embodiments as taught in the present disclosure provide several technical effects and advances to the field of authentication, identification, tracking, and many other fields as apparent to those of skill in the art. Technical effects and benefits include the ability to locate an obscure, non-descript authentication region on a physical object based on a more prominent anchor region on the physical object. These and other technical effects are implemented with scanning technology, digital image processing technology, and other computing technology.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

What is claimed is:

1. A method comprising:
capturing a plurality of digital images of a physical object;
while capturing the plurality of digital images, for each of the captured digital images:
determining in real-time if the digital image is of sufficient quality to determine an object type for the physical object from digital image data of the digital image;
determining in real-time an object type for the object when the digital image is of sufficient quality to determine an object type for the physical object from digital image data of the digital image; and
determining in real-time if the digital image is of sufficient quality to generate a digital fingerprint for the physical object from digital image data of the digital image; and
extracting features from one or more authentication regions of a digital image of the plurality of digital images, which has been determined to be of sufficient quality to generate a digital fingerprint for the physical object from digital image data of the digital image; and
generating a digital fingerprint for the object based on the extracted features.

2. The method of claim 1, further comprising storing the digital fingerprint for the physical object type in an authentication database to induct the physical object into the authentication database.

3. The method of claim 1, further comprising:
comparing the generated digital fingerprint to a plurality of stored digital fingerprints; and
determining a match between the generated digital fingerprint and one of the stored digital fingerprints to authenticate the physical object.

4. The method of claim 1, further comprising re-positioning the physical object relative to a camera used to capture the plurality of digital images between captures of different digital images of the plurality of digital images.

5. The method of claim 1, further comprising providing one or more indications to a user when a digital image is of sufficient quality to determine a digital fingerprint for the physical object from digital image data of the digital image.

6. The method of claim 5, further comprising providing one or more indications to a user when a digital image is of insufficient quality to generate a digital fingerprint for the physical object from digital image data of the digital image.

7. The method of claim 1, wherein determining if each digital image is of sufficient quality to generate a digital fingerprint for the physical object from digital image data of the digital image includes determining whether the digital image data of the digital image satisfy a plurality of quality metrics.

8. The method of claim 7, wherein the quality metrics include at least one of a distance quality metric, a focus quality metric, an illumination metric, a rotation metric, and a noise metric.

9. The method of claim 7, wherein the quality metrics are measured based on digital image data from the one or more authentication regions in the digital image.

10. The method of claim 7, further comprising providing a plurality of indications to a user, each indication representing a different one of the plurality of quality metrics, and each indication indicating whether a digital image satisfies the quality metric represented by the indication, wherein satisfying the quality metric is a requirement for generating a digital fingerprint for the physical object from digital image data of the digital image.

11. The method of claim 7, further comprising:
determining, for each digital image, a total quality metric based on the quality metrics measured for the image;
extracting features from one or more authentication regions of the digital image of the plurality of digital images, which has been determined to have a highest total quality metric of the plurality of digital images; and
generating the digital fingerprint for the object based on the extracted features.

12. The method of claim 1, wherein capturing the plurality of digital images of the physical object includes capturing the plurality of digital images at a rate greater than or equal to 24 Hz.

13. The method of claim 12, wherein determining in real-time if the digital image is of sufficient quality to generate a digital fingerprint for the physical object from digital image data of the digital image occurs within 0.5 seconds of the capture of the digital image.

14. The method of claim 1, wherein capturing the plurality of digital images of the physical object includes capturing the plurality of digital images at a rate greater than or equal to 60 Hz.

15. A system comprising:
a scanner configured for capturing a plurality of digital images of a physical object;
machine-readable memory storing executable instructions;
one or more processors configured to execute the stored instructions to cause the system to:
while the scanner captures the plurality of digital images, for each of the captured digital images:
determine in real-time if the digital image is of sufficient quality to determine an object type for the physical object from digital image data of the digital image;
determine in real-time an object type for the object when the digital image is of sufficient quality to determine an object type for the physical object from digital image data of the digital image; and
determine in real-time if the digital image is of sufficient quality to generate a digital fingerprint for the physical object from digital image data of the digital image; and
extract features from one or more authentication regions of a digital image of the plurality of digital images, which has been determined to be of sufficient quality to generate a digital fingerprint for the physical object from digital image data of the digital image; and
generate a digital fingerprint for the object based on the extracted features.

16. The system of claim 15, further comprising a display configured for providing one or more indications to a user when a digital image is of sufficient quality to determine a digital fingerprint for the physical object from digital image data of the digital image.

17. The system of claim 15, wherein determining if each digital image is of sufficient quality to generate a digital fingerprint for the physical object from digital image data of the digital image includes determining whether the digital image data of the digital image satisfy a plurality of quality metrics, wherein the quality metrics are measured based on digital image data from the one or more authentication regions in the digital image.

18. The system of claim 17, wherein the quality metrics include at least one of a distance quality metric, a focus quality metric, an illumination metric, a rotation metric, and a noise metric.

19. The system of claim 17, wherein the one or more processors are further configured to execute the stored instructions to cause the system to:
determine, for each digital image, a total quality metric based on the quality metrics measured for the image;
extract features from one or more authentication regions of the digital image of the plurality of digital images, which has been determined to have a highest total quality metric of the plurality of digital images; and
generate the digital fingerprint for the object based on the extracted features.

20. The system of claim 15, wherein the scanner is configured for capturing the plurality of digital images of the physical object at a rate greater than or equal to 24 Hz and wherein determining in real-time if the digital image is of sufficient quality to generate a digital fingerprint for the physical object from digital image data of the digital image occurs within 0.5 seconds of the capture of the digital image.
